(19) United States
(12) Patent Application Publication
(10) Pub. No.: US 2017/0337269 A1
(43) Pub. Date: Nov. 23, 2017

(54) SYSTEM FOR SHARING MUSICAL PREFERENCES

(71) Applicant: Charles Eugene Gafford, III, Oklahoma City, OK (US)

(72) Inventor: Charles Eugene Gafford, III, Oklahoma City, OK (US)

(21) Appl. No.: 15/598,155

(22) Filed: May 17, 2017

Related U.S. Application Data
(60) Provisional application No. 62/337,467, filed on May 17, 2016.

(51) Int. Cl. G06F 17/30; H04L 12/58; H04L 29/08; H04W 4/02

(52) U.S. Cl. CPC G06F 17/30772; H04L 67/306; H04L 51/32; G06F 17/30752; H04M 2250/10; H04W 4/023

(57) ABSTRACT

Systems and methods for facilitating user interaction based on musical preferences are described. In an embodiment, users are matched based on indication of the enjoyment of one another's musical playlists. In the embodiment, user's may only access the profile of another user if both users have indicated they have similar music preferences. In an embodiment, users are provided only with playlists from other users within a specified location range.

### CROSS-REFERENCE TO RELATED APPLICATION(S)

The present application claims priority to U.S. Provisional Patent Application No. 62/337,467 filed on May 17, 2016, entitled “SYSTEM FOR SHARING MUSICAL PREFERENCES” the entire disclosure of which is incorporated by reference herein.

### BACKGROUND OF THE INVENTION

### 1. Description of Related Art

There exists in the prior art online apps whereby users can connect with one another based on shared location, shared religious beliefs, and other common interests. Currently, these systems may draw information about users by prompting the users to fill out various questionnaires. The user's answers to sample template questions often can elicit information such as types of relationships they are seeking, user's age, the user's profession, and other types of background information to develop a user's profile for use within a given system. Often, these applications allow users to view other user profiles, pictures, and information before the parties have asserted mutual interest.

However, musical preference is often unaddressed by many of these online applications, although many people agree that shared musical preferences is an important part of social compatibility. Furthermore, creating connections based on shared musical preferences can help facilitate music discovery between parties. The primary driver of music sales in the past were based on CD sales. That model has now largely failed and with the advent of music file sharing followed by online individual tune sales, downloads and music streaming, it has now become a challenge to present a market for music, particularly for new music. Music presentation and discovery among parties can eventually lead to increased music sales for music, of artists and bands, being shared by parties.

Based on the foregoing, there is a need in the art for a system in which users can connect with one another based on musical preferences. The present invention overcomes the disadvantages of the prior art by maintaining the process of anonymity unless a match of mutual interest in musical taste occurs. In the present invention, the context of judgment in which a first user may observe a second user is limited to the musical tastes, preferences, and curated playlists of the second user.

### SUMMARY OF THE INVENTION

An embodiment of the present invention is provided to facilitate social interaction between users based on musical preferences. Wherein users create profiles and generate playlists with artists and songs of their preference.

In an embodiment, the user profiles remain hidden from one another, and users are only able to view each other's playlists. If two users indicate that they enjoy one another's playlists then they will be considered a matching pair. Each user in the matching pair will be notified, and each user will have access to the photos and information of the user they have matched with.

In an embodiment, a user specifies a range in which they which to connect with other users. In the embodiment, the user is only presented with playlists generated by users within the range they have specified.

In an embodiment, users which have formed a matching pair are able to listen to songs, albums, or playlist simultaneously, but from their own devices. In an embodiment, users which have formed a matched pair are also allowed to message one another using the system.

In an embodiment, the system and method is conducted by a computer-readable, non-transitory programmable product, comprising code executable by one or more processors.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is a flow chart showing steps performed in accordance with a preferred embodiment of the present invention to register and connect new users in the system.

### DETAILED DESCRIPTION OF PREFERRED EMBODIMENTS

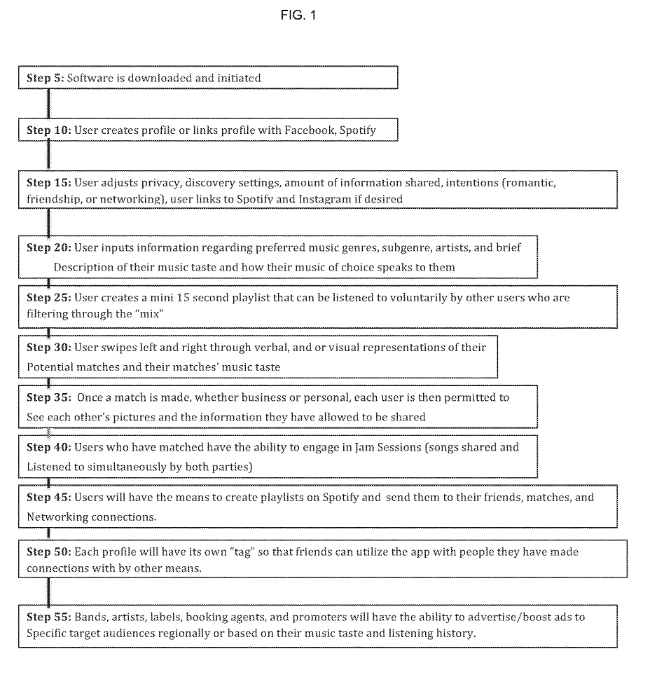

Preferred embodiments of the present invention and their advantages may be understood by referring to FIG. 1, wherein like reference numerals refer to like elements.

In an embodiment, the present invention provides a way for people to indicate their mutual interests in music and romantic intentions. A computer system includes a processor, memory, and a database. The database contains information relating to musical interests entered by human beings, hereinafter users. The system preferably connects to a display device, such as a display screen on a mobile phone that can be connected to a network in which it can communicate with other computer systems over a connection. The steps of FIG. 1 are performed by a processor and implemented as computer instructions of software executed by a processor.

In and embodiment, the present invention also provides a way of notifying users of shared attraction or interests. The system maintains a certain level of anonymity of the participants because no notification or pictures of a user can be shared unless the system has determined that a match in musical interests exists.

In and embodiment, in step 5, the user downloads the software from the app store from either an iOS or android smartphone. The system then determines that the user wants to enter a new profile. In step 10, the user creates a profile or links his or her profile with their Facebook, Instagram, and/or Spotify profile. Alternatively, a user profile or user ID may be assigned an alphanumeric handle, a user's name, a user's email address, or other personal form of identification. The user may also provide photos of themselves to their corresponding profile and user id.

In an embodiment, the user may personalize their privacy settings, discovery settings, and amount of information shared with other users using the system. In step 15, the user selects a stated intention selected from the group consisting of romantic, friendship, or networking. In an embodiment, if a user selects romantic as his or her stated intention, they may connect with other users who have also selected romantic as their stated intention.

In further accordance with the purpose of this invention, an embodiment of the present system provides a method which notifies users that they feel mutual interest, comprising a first input portion configured to receive input from a first user indicating a user ID of a first object in whom the first user has an interest; a second input portion, configured to receive input from a second user indicating a user ID of a second object in whom the second user has an interest; a matching algorithm in which the system is configured to determine whether the user ID of the first object matches a user ID of the second user and whether the user ID of the second object matches a user ID of the first user; and a method for notifying both the first user and second user that a match has been detected, wherein the notification may be performed at a predetermined interval.

After the user has created a profile, selected a stated preference, and controlled for privacy and discovery settings, the user inputs information regarding preferred music genres, subgenre, artists, and a brief description of their musical tastes. The present system allows for a unique user ID to correspond to an individual user profile. All user ID's may be stored on an application server.

In reference to FIG. 1, a host server facilitates the system in combination with the user's device, preferably through the use of software installed on participating devices such as an application that is downloaded and run on the device. A music management module can manage user contacts.

In an embodiment, at step 25, a first user may create a 15-60 second playlist comprised of a selection of songs that can be listened to by other users voluntarily after searching for other users. Further, a first user may create a subset of music artists who he or she considers his favorites or listens to most frequently. A first user's curated playlist and preferred artists can be viewed by other users regardless of the first user's stated intention. Following, a second user may listen or view the first user's artists and playlist and indicate that he or she approves of or otherwise likes the first user's selections.

In and embodiment, at step 30 a first user is presented with other user's playlists. For each individual playlist, the first user may listen to a playlist, and swipe left on the interface if the first user does not share similar taste in music or otherwise disapproves or dislikes the music. In this embodiment, the playlist and corresponding user will not be presented to the first user ever again. After the first user has swiped left, the first user will be presented with another user's corresponding playlist. The system collects this notification and periodically searches for matches.

In another embodiment, the first user may listen to another user's playlist and swipe right on the interface if the first user does share similar taste in music or otherwise approves or likes the music. In this embodiment, the playlist and corresponding user can be stored to a save database on an application server wherein the first user can repeatedly make contact, directly message, and listen again to the user's playlist.

In another exemplary embodiment, a first user may listen to a second user's playlist and swipe right on the interface if the first user likes or shares similar taste in music, or otherwise approves or likes the music. Where the second user has not swiped right or left on the first user's playlist or profile, the first user's profile and corresponding playlist will be presented at the front of the queue of all system user profiles to be presented to the second user at the next opportunity the second user is discovering new users within the system. This preferred embodiment allows for an algorithm that produces higher levels of matches between users. When a first user has liked a second user's playlist, and the second user has not been made aware of the first user, the first user will be presented to the second user before other users profiles are presented to the second user. This queue provides for a second user to have a queue of users who have already swiped right, or initiated the first half of a match. In a preferred embodiment, after the first user has viewed the queue of users who have already swiped right, other users who are within a close GPS proximity will be presented to the first user.

In an embodiment, where two unique users have both swiped right with one another, a match is indicated. In step 35, once a match is made, whether business or personal, each user is then permitted to see each other's pictures and the information they have allowed to be shared. No notification occurs unless the system determines that a match in interests or music exists. If a first user approval of a second user is not mirrored, the system will not notify either user and only the system server will be aware of a first user's approval of a second non-approving user.

In an embodiment, at step 40, after a match has been indicated, users have the ability to engage in communication called Jam Sessions where individual songs are shared and listened to simultaneously by both users. Further, after a match has been indicated, users will be able to see pictures and linked social media profiles of one another. It should be noted that the initial representation of one user to another would be exclusively based on the user's playlist or collection of favorite artists. In a preferred embodiment, a first user may only view pictures, linked social media profiles, and otherwise engage with or communicate with another user after a match has been indicated. At step 45, users who have the means to create playlists on Spotify and send them to their friends, matches, and networking connections where mutual interests have been made.

In an embodiment, users will be able to tag or reference other user's unique id or profile where they have already been matched with one another and have the ability to communicate. A first user may tag a second so that connections may share the app with other users.

In an embodiment, users may be able to organize their matches or connections into user created subsets and groups. Matches may be initially categorized by their respective user stated intention, but a user can reorganize and categorize their matches. At step 50, a user may also send group messages, music videos, and playlists to groups of matched users that the first user has created.

It is a further goal of this invention to allow for bands, artists, labels, booking agents, and promoters to advertise and create sponsored pages with playlists. These pages will have a unique user id and can directly communicate with users in the system. At step 55, these parties may advertise to specific target audiences regionally or based on their music taste and listening history. In an embodiment, the system may utilize the GPS location of users to push specific ads related to venues, bands, and other festivals that are coming up in geographical areas close to groups of users.

In an embodiment, the system may utilize syndicated videos from video hosting services such as VEVO, Sony Music, and UMG. In another embodiment, a user may elect to go on a “road trip” and relocate themselves to a new set of GPS coordinates in order to view location specific advertisements about concerts and venues in another part of the world. Further, a user will be able to view profiles and playlists of other users that are in close proximity to the new, elected GPS coordinates chosen by the first user.

In an embodiment, the system may offer a variety of payment structures in which the users may pay a tiered monthly subscription fee, a pay per feature fee, or other payment structure. This system can alternatively be a “free-mium” service that offers in-app purchases.

In an embodiment, the system may link users to outside sources to purchase music which they have discovered through other users. As record stores have fallen by the wayside, the system provides a new avenue of music discovery, advertising, and purchase.

The system of the invention or portions of the system of the invention may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device (“PLD”) such as a Field-Programmable Gate Array (“FPGA”), Programmable Logic Array (“PLA”), or Programmable Array Logic (“PAL”), or any other device or arrangement of devices that is capable of implementing the steps of the processes of the invention.

The processing machine used to implement the invention may utilize a suitable operating system. Thus, embodiments of the invention may include a processing machine running the iOS operating system, the OS X operating system, the Android operating system, the Microsoft Windows™ 8 operating system, Microsoft Windows™ 7 operating system, the Microsoft Windows™ Vista™ operating system, the Microsoft Windows™ XP™ operating system, the Microsoft Windows™ NT™ operating system, the Windows™ 2000 operating system, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity, i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention. The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claim.

I claim:

1. A method for facilitating music-based social interaction, the method comprising:
a. receiving input from a first user to generate a playlist of songs;
b. receiving input from the second user to generate a playlist of songs;
c. providing the first user with the playlist of songs generated by input from the second user; and
d. providing the second user with the playlist of songs generated by input from the first user;
wherein the users are able to indicate they enjoy the playlists of songs generated by one another, and wherein if both users indicate the playlist of songs generated by the other user they are considered a matching pair.

2. The method for facilitating music-based social interaction of claim 1, the method further comprising the step of notifying the first user and the second user that they are a matching pair.

3. The method for facilitating music-based social interaction of claim 1, the method further comprising the step to provide the users of the matching pair with pictures and biographical information of one another.

4. The method for facilitating music-based social interaction of claim 1, wherein the first user is only provided with the playlist of songs generated by input from the second user if the second user is within a specified range of the first user.

5. The method for facilitating music-based social interaction of claim 1, wherein the first user and the second user of the matching pair are able to listen to a specified playlist simultaneously, and wherein the first user listens to the specified playlist on a first device, and wherein the second user listens to the specified playlist on a second device.

6. The method for facilitating music-based social interaction of claim 1, wherein the first user and the second user of the matching pair are able to message one another.

7. The method for facilitating music-based social interaction of claim 1, wherein the first user is able to create a group consisting of a plurality of users which they have matched with.

8. The method for facilitating music-based social interaction of claim 7, wherein the plurality of users of the group are able to message one another.

9. A computer-readable, non-transitory programmable product, for notifying people that they possess common music interests with each other, comprising code executable by one or more processors, to cause the one or more processors to do the following:
a. receive input from a first user to generate a playlist of songs;
b. receive input from the second user to generate a playlist of songs;
c. receive input from the second user indicating they enjoy the playlist of songs generated by the second user;
d. receive input from the second user indicating they enjoy the playlist of songs generated by the first user;
e. notify the first user that the second user enjoys the playlist of songs generated by the first user; and
f. notify the second user that the first user enjoys the playlist of songs generated by the second user;
wherein the first user and second user are considered to be a matching pair upon an indication that they enjoy each other's playlists of songs.

10. The computer-readable, non-transitory programmable product as recited in claim 9, wherein the matching pair is able to listen to one or more songs simultaneously.

11. The computer-readable, non-transitory programmable product as recited in claim 9, wherein the matching pair is able to send messages to one another.

12. The computer-readable, non-transitory programmable product as recited in claim 9, wherein the first user of the matching pair is able to view pictures and info provided by the second user of the matching pair.

13. The computer-readable, non-transitory programmable product as recited in claim 9, wherein the second user of the matching pair is able to view pictures and info provided by the first user of the matching pair.

14. The computer-readable, non-transitory programmable product as recited in claim 9, wherein the first user is only provided with the playlist of songs generated by the second user if the second user is located within a specified proximity of the first user.

15. The computer-readable, non-transitory programmable product as recited in claim 9, wherein the locations of the first and second users are determined by global positioning systems.

16. The computer-readable, non-transitory programmable product as recited in claim 9, wherein the first user may create a group with a plurality of users whom they have formed matching pairs with.

17. The computer-readable, non-transitory programmable product as recited in claim 16, wherein the plurality of users in the group message one another.
